(19) United States
(12) Patent Application Publication
(10) Pub. No.: US 2009/0172927 A1
(43) Pub. Date: Jul. 9, 2009

(54) HOLDING DEVICE

(76) Inventor: Chi-Wen Chen, Taipei City (TW)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(21) Appl. No.: 11/969,824

(22) Filed: Jan. 4, 2008

(51) Int. Cl. B25B 5/00

(52) U.S. Cl. 24/456

(57) ABSTRACT

A holding device includes: a clamping member including a frame that defines a frame space, and a screw rod engaging threadedly the frame and extending into the frame space; a movable supporting arm mounted movably on the frame; a fastening member connected to the movable supporting arm and the frame for securing releasably the movable supporting arm to the frame; and a holding member mounted rotatably on the movable supporting arm.

### BACKGROUND OF THE INVENTION

1. Field of the Invention

The invention relates to a holding device, more particularly to a holding device including a clamping member and a movable supporting arm movable on the clamping member.

2. Description of the Related Art

A conventional tool box holding device normally includes a clamping member and a mounting rack fixed to the clamping member. In use, the clamping member is fastened to a plate-like object, such as the top of a working table, near a working site, and the mounting rack serves to support a tool box containing tools that the user can fetch conveniently when working at the working site. However, since the mounting rack is fixed to the clamping member, fetching of the tools from the tool box on the mounting rack can be still inconvenient in certain situations.

### SUMMARY OF THE INVENTION

Therefore, the object of the present invention is to provide a holding device that can overcome the aforesaid drawback of the prior art.

Accordingly, a holding device of the present invention includes: a clamping member including a frame that defines a frame space, and a screw rod engaging threadedly the frame and extending into the frame space; a movable supporting arm mounted movably on the frame; a fastening member connected to the movable supporting arm and the frame for securing releasably the movable supporting arm to the frame; and a holding member mounted rotatably on the movable supporting arm.

### BRIEF DESCRIPTION OF THE DRAWINGS

Other features and advantages of the present invention will become apparent in the following detailed description of the preferred embodiment with reference to the accompanying drawings, of which:

FIG. 1 is an exploded perspective view of the preferred embodiment of a holding device according to the present invention;

FIG. 2 is an assembled perspective view of the preferred embodiment incorporated with an object to be held;

FIG. 3 is a partly sectional view of the preferred embodiment, illustrating an abutting element disposed at a fastened position;

FIG. 4 is a partly sectional view of the preferred embodiment, illustrating the abutting element disposed at an unfastened position; and

FIG. 5 is a top view of the preferred embodiment, illustrating a holding member pivoted about a movable supporting arm.

### DETAILED DESCRIPTION OF THE PREFERRED EMBODIMENT

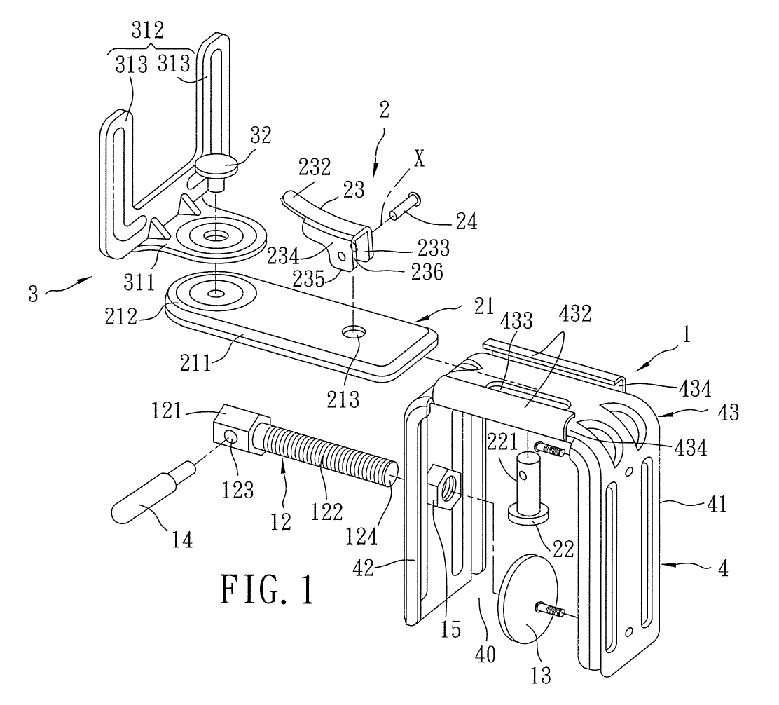

Referring to FIGS. 1 to 3, the preferred embodiment of a holding device according to the present invention includes: a clamping member 1 including a frame 4 that defines a frame space 40, and a screw rod 12 engaging threadedly the frame 4 and extending into the frame space 40; a movable supporting arm 21 mounted movably on the frame 4; a fastening member 2 connected to the movable supporting arm 21 and the frame 4 for securing releasably the movable supporting arm 21 to the frame 4; and a holding member 3 mounted rotatably on the movable supporting arm 21.

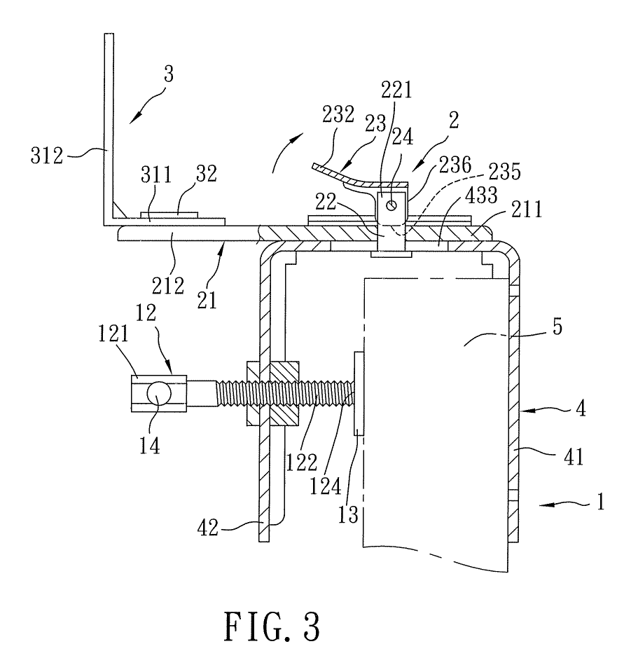

The holding device is adapted to be fastened to an object, such as a top of a table. In this embodiment, the object has a plate 5 to which the holding device can be fastened, as best illustrated in FIG. 3.

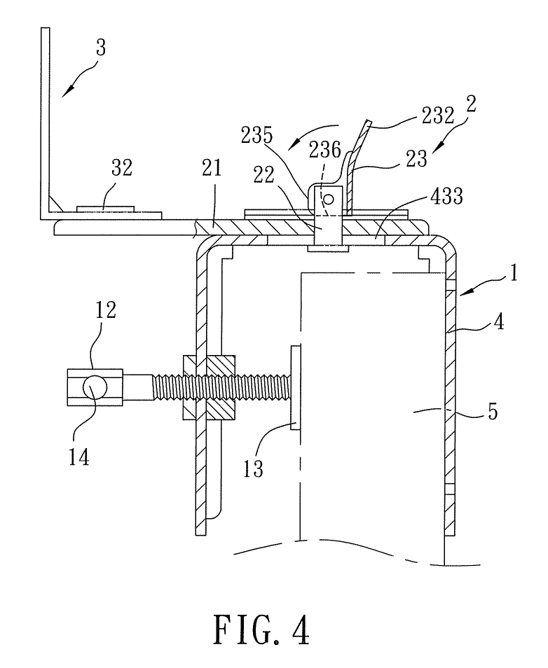

The frame 4 has a mounting wall 43 that is formed with a track 432 extending in an arm-moving direction, and a slot 433 extending in the arm-moving direction. The movable supporting arm 21 has a sliding plate 211 slidable along the track 432. The fastening member 2 includes a headed shaft 22 disposed in the frame space 40 and having an end portion 221 extending through the slot 433 and the sliding plate 211 and into the track 432, and an abutting element 23 pivoted to the end portion 221 of the headed shaft 22 through a pivot pin 24, having first and second end faces 235, 236 that face in different directions, and rotatable relative to the headed shaft 22 about an axis (X), defined by the pivot pin 24, between fastened and unfastened positions (see FIGS. 3 and 4). The distance between the first end face 235 and the axis (X) is greater than that between the second end face 236 and the axis (X) such that the first end face 235 presses the sliding plate 211 to abut against the mounting wall 43 of the frame 4 when the abutting element 23 is disposed at the fastened position (see FIG. 3), and the second end face 236 faces the sliding plate 211 when the abutting element 23 is disposed at the unfastened position (see FIG. 4). In this embodiment, the first and second end faces 235, 236 of the abutting element 23 cooperatively form an L-shaped surface. The abutting element 23 includes an operating lever 232 and two opposite side walls 234 extending transversely from the operating lever 232 and defining a gap 233 for extension of the headed shaft 22 therein. The pivot pin 24 extends through the side walls 234.

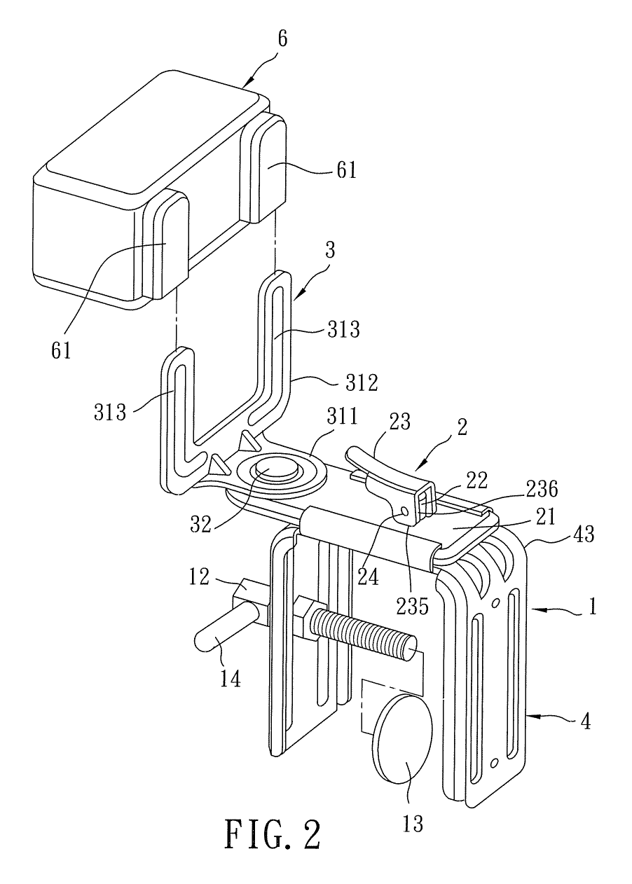

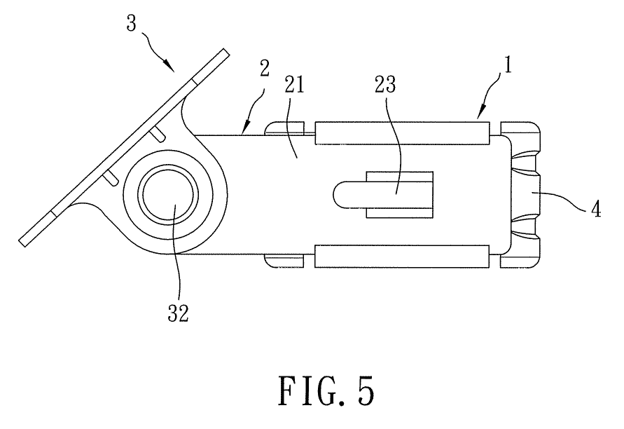

The track 432 further defines two opposite guiding grooves 434. The sliding plate 211 has two opposite sides respectively received in the guiding grooves 434. The sliding plate 211 has a pivot end 212 disposed outwardly of the track 432. The holding member 3 has a holding plate 312 and a pivot plate 311 extending transversely from the holding plate 312 and pivoted to the pivot end 212 of the sliding plate 211 through a pivot 32 (see FIG. 5). The holding plate 312 has bifurcated prongs 313 for supporting a tool box 6 (see FIG. 2) which has a pair of prong-inserting members 61 for extension of the prongs 313 therein.

The frame 4 further includes first and second side walls 41, 42 extending transversely and downwardly from opposite edges of the mounting wall 43 to form a U-shaped structure. The screw rod 12 has a threaded shank 122 and a screw head 121. The screw head 121 is formed with a handle hole 123. A handle 14 is inserted fittingly into the handle hole 123 for easy operation of the screw rod 12. A nut 15 is fixed to the second side wall 42 of the frame 4, and engages threadedly the screw rod 12. An abutting pad 13 is fixed to an end 124 of the threaded shank 122 for pressing the plate 5 to abut against the first side wall 41 of the frame 4 during use.

With the inclusion of the track 432 and the movable supporting arm 21 in the holding device of this invention, the aforesaid inconvenience when fetching tools from the tool box as encountered in the conventional holding device can be eliminated.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

What is claimed is:

1. A holding device comprising:
a clamping member including a frame that defines a frame space, and a screw rod engaging threadedly said frame and extending into said frame space;
a movable supporting arm mounted movably on said frame;
a fastening member connected to said movable supporting arm and said frame for securing releasably said movable supporting arm to said frame; and
a holding member mounted rotatably on said movable supporting arm.

2. The holding device as claimed in claim 1, wherein said frame has a mounting wall that is formed with a track extending in an arm-moving direction, and a slot extending in the arm-moving direction, said movable supporting arm having a sliding plate slidable along said track, said fastening member including a headed shaft having an end portion extending through said slot and said sliding plate and into said track, and an abutting element pivoted to said end portion of said headed shaft, having first and second end faces that face in different directions, and rotatable relative to said headed shaft about an axis between fastened and unfastened positions, the distance between said first end face and said axis being greater than that between said second end face and said axis, said first end face pressing said sliding plate to abut against said mounting wall of said frame when said abutting element is disposed at the fastened position, said second end face facing said sliding plate when said abutting element is disposed at the unfastened position.

3. The holding device as claimed in claim 1, wherein said frame has a mounting wall that is formed with a track extending in an arm-moving direction and defining two opposite guiding grooves, said movable supporting arm having a sliding plate with two opposite sides respectively received in said guiding grooves.

4. The holding device as claimed in claim 3, wherein said sliding plate has a pivot end disposed outwardly of said track, said holding member having a holding plate and a pivot plate extending transversely from said holding plate and pivoted to said pivot end of said sliding plate.
